(19) United States
(12) Patent Application Publication
(10) Pub. No.: US 2010/0225844 A1
(43) Pub. Date: Sep. 9, 2010

(54) LAMP HOLDER, BACKLIGHT UNIT, AND LIQUID CRYSTAL DISPLAY DEVICE

(75) Inventor: Kentaro Kamada, Kameyama-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/997,422

(22) PCT Filed: Jun. 5, 2006
(86) PCT No.: PCT/JP2006/311219

§ 371 Date: Jan. 31, 2008

(30) Foreign Application Priority Data
Aug. 5, 2005 (JP) 2005-227795

(51) Int. Cl. G02F 1/1333; F21V 17/06; G02F 1/13357

(52) U.S. Cl. 349/58; 362/433; 362/97.1

(57) ABSTRACT

A lamp holder is attached to an end of a narrow lamp to secure the lamp to an edge of a reflector for reflecting light from the lamp and has an abutment surface abutting a surface of the edge of the reflector and a sandwiching portion arranged to sandwich the edge of the reflector between the abutment surface and the sandwiching portion.

### TECHNICAL FIELD

The present invention relates to a lamp holder. In particular, it relates to a lamp holder attached to both ends of a lamp of a backlight unit of a liquid crystal display device.

### BACKGROUND ART

Transmissive liquid crystal display device includes a liquid crystal display panel including a pair of substrates arranged to face each other, a liquid crystal layer provided between the pair of substrates and a backlight unit for introducing light to the liquid crystal display panel. According to the transmissive liquid crystal display device, the orientation of liquid crystal molecules in the liquid crystal layer is varied in response to the magnitude of a voltage applied to the liquid crystal layer, thereby adjusting transmittance of light entering from the backlight unit. In this way, image display is realized.

The backlight unit includes a lamp such as a cathode discharge tube and a reflector arranged near the lamp. The lamp of the backlight unit is secured onto the reflector by a lamp holder attached to both ends of the lamp. For example, Patent Literatures 1, 2 and 3 disclose various kinds of lamp holders and methods for securing them.

[Patent Literature 1] Japanese Unexamined Patent Publication No. 8-15702

[Patent Literature 2] Japanese Unexamined Patent Publication No. 2002-156622

[Patent Literature 3] Japanese Unexamined Patent Publication No. 2004-348150

### DISCLOSURE OF THE INVENTION

### Problem that the Invention is to Solve

FIG. 9 is a perspective view illustrating a major part of a conventional backlight unit 110.

The backlight unit 110 includes a narrow lamp 101, a rubber lamp holder 102 attached to the end of the lamp 101 and a reflector 104 carrying the lamp holder 102 at the edge thereof. The lamp holder 102 has an abutment surface T abutting the surface of the reflector 104 and arranged in an upright position on the reflector 104.

The above-described backlight unit 110 has a problem in that the lamp 101 wobbles on the reflector 104 when external oscillation is applied. In particular, a direct backlight unit includes a plurality of lamps arranged parallel to each other along the reflector. Therefore, it is necessary to attach the lamps to the reflector with care such that they do not come off. This leads to reduction of workability.

In view of the foregoing, the present invention has been achieved. An object of the present invention is to restrain the lamp on the reflector from wobbling.

### Means of Solving the Problem

In order to achieve the above-described object, the lamp holder of the present invention is configured to have a sandwiching part for sandwiching the edge of the reflector between the abutment surface and the sandwiching part.

To be more specific, the lamp holder of the present invention is a lamp holder attached to an end of a narrow lamp to secure the lamp to an edge of a reflector for reflecting light from the lamp, the lamp holder including an abutment surface abutting a surface of the edge of the reflector, wherein the lamp holder has a sandwiching part for sandwiching the edge of the reflector between the abutment surface and the sandwiching part.

With this configuration, the edge of the reflector is sandwiched between the abutment surface and the sandwiching part of the lamp holder. Therefore, the lamp holder is reliably secured to the edge of the reflector. Since the lamp holder is attached to the end of the lamp, the lamp is restrained from wobbling on the reflector.

The sandwiching part may be a cutout groove formed continuously with the abutment surface.

With this configuration, the edge of the reflector is fitted in the cutout groove of the lamp holder. Therefore, the lamp holder is reliably secured to the edge of the reflector.

The width of the cutout groove may be increased toward an opening of the cutout groove.

With this configuration, the edge of the reflector is easily fitted in the cutout groove of the lamp holder.

The sandwiching part may be configured of an outward protrusion.

With this configuration, the edge of the reflector is sandwiched between the abutment surface and the protrusion of the lamp holder. Therefore, the lamp holder is reliably secured to the edge of the reflector.

A backlight unit of the present invention includes a narrow lamp, a reflector for reflecting light from the lamp and a lamp holder attached to an end of the lamp to secure the lamp to an edge of the reflector, wherein the lamp holder includes an abutment surface abutting a surface of the edge of the reflector and a sandwiching part for sandwiching the edge of the reflector between the abutment surface and the sandwiching part.

With this configuration, the edge of the reflector is sandwiched between the abutment surface and the sandwiching part of the lamp holder. Therefore, the lamp holder is reliably secured to the edge of the reflector. Since the lamp holder is attached to the end of the lamp, the lamp of the backlight unit is restrained from wobbling on the reflector.

A plurality of the lamps may be arranged parallel to each other along the reflector.

With this configuration, even if the plurality of lamps are arranged along the reflector, the lamp holders reliably secure the lamps to the edge of the reflector. Therefore, the workability of attaching the lamps on the reflector is less likely to be reduced.

A liquid crystal display device of the present invention includes a liquid crystal display panel and a backlight unit arranged to face a display surface of the liquid crystal display panel. The backlight unit includes a narrow lamp, a reflector for reflecting light from the lamp and a lamp holder attached to an end of the lamp to secure the lamp to an edge of the reflector and the lamp holder includes an abutment surface abutting a surface of the edge of the reflector and a sandwiching part for sandwiching the edge of the reflector between the abutment surface and the sandwiching part.

With this configuration, the edge of the reflector is sandwiched between the abutment surface and the sandwiching part of the lamp holder. Therefore, the lamp holder is reliably secured to the edge of the reflector. Since the lamp holder is attached to the end of the lamp, the lamp of the backlight unit of the liquid crystal display device is restrained from wobbling on the reflector.

### EFFECT OF THE INVENTION

According to the present invention, the lamp holder has the sandwiching part for sandwiching the edge of the reflector between the abutment surface and the sandwiching part.

Therefore, the lamp is restrained from wobbling on the reflector.

### BRIEF DESCRIPTION OF DRAWINGS

FIG. 1 is an exploded perspective view illustrating a liquid crystal display device 50 of Embodiment 1.

FIG. 2 is a perspective view illustrating a major part of a backlight unit 10 of Embodiment 1.

FIG. 3 is a sectional view of a lamp holder 2 taken along the line III-III of FIG. 2.

FIG. 4 is a top view of the lamp holder 2.

FIG. 5 is a sectional view of a lamp holder 2a corresponding to FIG. 3.

FIG. 6 is a sectional view of a lamp holder 2b corresponding to FIG. 3.

FIG. 7 is a sectional view of a lamp holder 2c of Embodiment 2 corresponding to FIG. 3.

FIG. 8 is a bottom view of the lamp holder 2c.

FIG. 9 is a perspective view illustrating a major part of a conventional backlight unit 110.

### EXPLANATION OF REFERENCE NUMERALS

D Display surface
T Abutment surface
1 Lamp
2, 2a, 2b, 2c Lamp holder
4 Reflector
7, 7a, 7b Cutout groove (sandwiching part)
7c Protrusion (sandwiching part)
10 Backlight unit
20 Liquid crystal display panel
50 Liquid crystal display device

### BEST MODE FOR CARRYING OUT THE INVENTION

Hereinafter, embodiments of the present invention will be explained in detail with reference to the drawings. The embodiments do not intend to limit the present invention.

### Embodiment 1

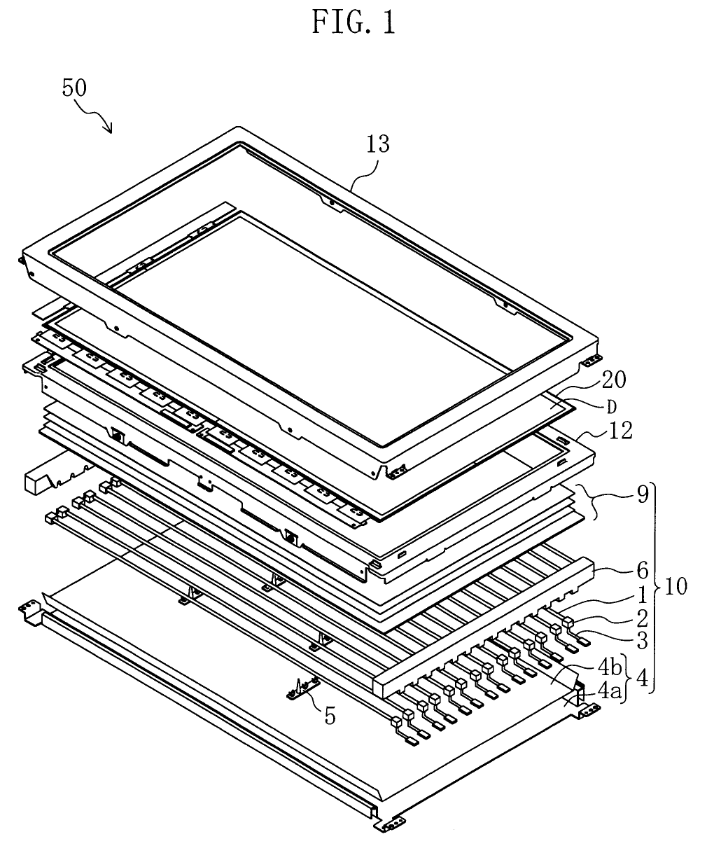

FIGS. 1 to 6 illustrate a lamp holder, a backlight unit and a liquid crystal display device according to Embodiment 1 of the present invention.

FIG. 1 is an exploded perspective view of the liquid crystal display device 50 of the present embodiment.

The liquid crystal display device 50 includes, as shown in FIG. 1, a liquid crystal display panel 20 having a display surface D, a frame 12 for holding the liquid crystal display panel 20 from below, a direct backlight unit 10 arranged below the frame 12 to face the display surface D of the liquid crystal display panel 20 and a bezel 13 arranged on the liquid crystal display panel 20 and secured to the backlight unit 10 and the frame 12.

The liquid crystal display panel 20 includes, for example, an active matrix substrate (not shown) and a counter substrate (not shown) arranged to face each other, a liquid crystal layer (not shown) arranged between the substrates and polarizers (not shown) bonded to the display surfaces D of the active matrix substrate and the counter substrate.

The active matrix substrate includes a glass substrate, a plurality of gate lines provided on the glass substrate to be parallel to each other, a plurality of source lines provided on the glass substrate to be perpendicular to the gate lines, TFTs provided as switching elements at the intersections of the gate lines and the source lines, respectively, pixel electrodes provided for every region surrounded by an adjacent pair of gate lines and an adjacent pair of source lines and an orientation film provided to cover the pixel electrodes. The pixel electrodes are arranged in a matrix pattern to provide a display region (display surface D) and each of the pixel electrodes constitutes a pixel, a minimum unit of an image.

The counter substrate includes a glass substrate, a color filter layer provided on the glass substrate, an overcoat layer provided to cover the color filter layer, a shared electrode provided to cover the overcoat layer and an orientation film provided to cover the shared electrode.

The liquid crystal layer contains nematic liquid crystal (liquid crystal molecules) having an electro-optic property.

The polarizer functions to allow transmission of a portion of incident light polarized in a certain direction.

The frame 12 is made of a plate of metal such as stainless steel and in the form of a frame to allow light from the backlight unit 10 to directly enter the liquid crystal display panel 20.

The backlight unit 10 includes a reflector 4, a plurality of lamps 1 arranged on the reflector 4 to be parallel to each other, lamp holders 2 attached to both ends of each lamp 1 and secured to the edges of the reflector 4, lamp holder retainers 6 accommodated in the frame 12 and retain the lamp holders 2 from above and an optical sheet 9 provided above the lamps 1.

The reflector 4 includes a chassis 4a made of a plate of metal such as stainless steel and a reflective sheet 4b made of a white plastic sheet formed on the top surface of the chassis 4a.

The lamps 1 may be, for example, cathode discharge tubes, respectively. Harnesses 3 for applying voltage to the lamps 1 are connected to both ends of the lamps 1.

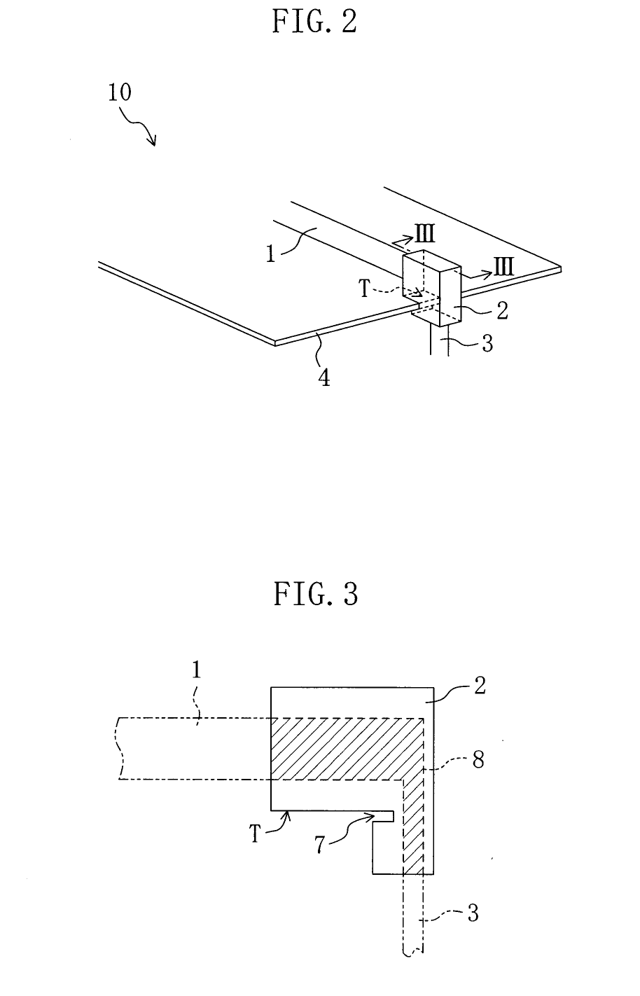

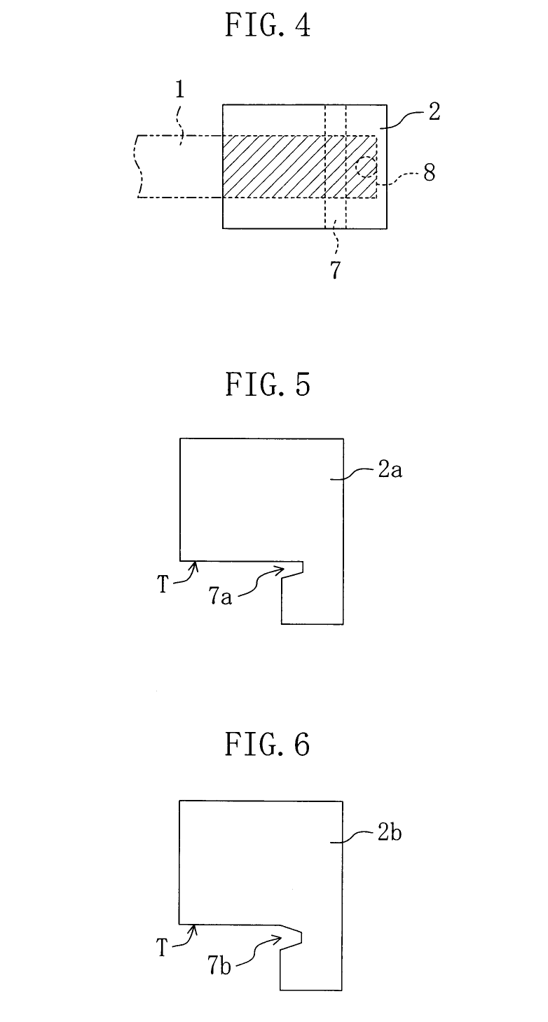

Each of the lamp holders 2 is made of elastic material such as rubber. As shown in FIGS. 2, 3 and 4, the lamp holder 2 has an abutment surface T abutting the surface of the edge of the reflector 4 and an L-shaped through hole 8 for receiving the end of the lamp 1 and the end of the harness 3. FIG. 2 is a perspective view illustrating a major part of the backlight unit 10, FIG. 3 is a sectional view of the lamp holder 2 taken along the line III-III of FIG. 2 and FIG. 4 is a top view of the lamp holder 2.

As a feature of the present invention, the lamp holder 2 has a cutout groove 7 formed continuously with the abutment surface T and adapted to function as a sandwiching part for holding the edge of the reflector 4 therein.

Lamp clips 5 for supporting the middle parts of the narrow lamps 1 are provided on the reflector 4. The lamp clips 5 are provided with protrusions for supporting the optical sheet 9 from below.

The optical sheet 9 may be a light diffusion film for diffusing light from the lamps 1.

A bezel 13 is a frame-shaped component made of a plate of metal such as stainless steel and adapted to expose the display surface D of the liquid crystal display panel 20.

In the thus-configured liquid crystal display device 50, a gate signal is supplied to the TFT in each pixel of the liquid crystal display panel 20 through the gate line to turn the TFT on, and simultaneously, a source signal is supplied to the pixel electrode through the source line and the TFT to write a certain charge in the pixel electrode. At this time, potential difference arises between the pixel electrode on the active matrix substrate and the shared electrode on the counter substrate and a certain voltage is applied to the liquid crystal layer, i.e., liquid crystal capacity. In each pixel of the liquid crystal display device 50, the orientation of the liquid crystal molecules in the liquid crystal layer is varied depending on the magnitude of the applied voltage. Based on the phenomenon, the transmittance of light entering from the backlight unit 10 to the liquid crystal display panel 20 is adjusted. In this manner, image display is achieved.

Now, an example of a method for manufacturing the above-described liquid crystal display device 50 will be explained. The liquid crystal display device 50 is manufactured by sequentially carrying out an active matrix substrate production process, a counter substrate production process, a liquid crystal display panel production process and an assembly process described below.

First, in the active matrix substrate production process, the above-described lines, TFTs, pixel electrodes and orientation film are formed on a glass substrate.

In the counter substrate production process concurrently performed with the active matrix substrate production process, the color filter layer, the shared electrode and the orientation film are formed on a glass substrate.

In the next liquid crystal display panel production process, a sealant is applied onto one of the substrates obtained by the active matrix substrate production process and the counter substrate production process. The sealant is applied in the form of a frame while leaving a liquid crystal injection hole. On the other substrate, spherical spacers having a diameter corresponding to the thickness of the liquid crystal layer are arranged. Then, the substrates are bonded together and the sealant is cured to obtain an empty liquid crystal display panel without liquid crystal.

Liquid crystal is injected into the empty liquid crystal display panel in which pressure has been reduced. Then, UV curable resin is applied to the liquid crystal injection hole and irradiated with UV light to seal the liquid crystal in the panel.

Further, polarizers are bonded to the surfaces of the active matrix substrate and the counter substrate of the liquid crystal display panel, respectively.

The liquid crystal display panel 20 is manufactured in the above-described manner. Components such as a driver IC are additionally attached to the liquid crystal display panel 20.

In the following assembly process, the reflection sheet 4b is bonded onto the top surface of the chassis 4a to form the reflector 4. Then, lamp clips 5 are attached at certain positions on the top surface of the reflector 4.

Then, the lamps 1 each of which having leads soldered at both ends thereof are prepared. Each of the leads is inserted into the through hole 8 formed in each of the lamp holders 2 such that the lamp holders 2 are attached to both ends of the lamps 1. Then, connectors are attached to the ends of the leads to form the harnesses 3.

The middle parts of the lamps 1 are attached to the lamp clips 5 on the reflector 4 and the edges of the reflector 4 are fitted in the cutout grooves 7 of the lamp holders 2 attached to the both ends of the lamps 1. Since the edges of the reflector 4 are fitted in the cutout grooves 7 of the lamp holders 2, the lamp holders 2 are reliably secured to the edges of the reflector 4 and the lamps 1 are restrained from wobbling on the reflector 4.

Then, lamp holder retainers 6 are attached to cover the top surfaces of the lamp holders 2 secured to the both edges of the reflector 4.

The optical sheet 9 is then arranged such that it abuts the top surface of the protrusions of the lamp clips 5.

The frame 12 is arranged such that it accommodates therein the lamp holder retainers 6 arranged on the top surface of the reflector 4.

Then, the liquid crystal display panel 20 is attached to a certain position of the top surface of the frame 12 and the bezel 13 is arranged thereon to expose the display surface D of the liquid crystal display panel 20. The bezel 13, the frame 12 and the reflector 4 are secured together by screws.

In the foregoing manner, the liquid crystal display device 50 is manufactured.

As described above, in the liquid crystal display device 50 of the present embodiment, both edges of the reflector 4 are fitted in the cutout grooves 7 of the lamp holders 2. Therefore, the lamp holders 2 are reliably secured to the edges of the reflector 4. Since the lamp holders 2 are attached to the ends of the lamps 1, the lamps 1 of the backlight unit 10 are restrained from wobbling on the reflector 4. Further, since the lamp holders 2 are reliably secured to the edges of the reflector 4, the lamp clips 5 on the reflector 4 may be omitted or reduced. As the wobbling of the lamps 1 on the reflector 4 is restrained, the workability of attaching the lamps 1 to the reflector 4 is less likely to be reduced.

According to the present embodiment, the cutout grooves 7 have uniform width as shown in FIG. 3. However, the present invention is not limited thereto. For example, the cutout groove 7 may be replaced with a cutout groove 7a shown in FIG. 5 or a cutout groove 7b shown in FIG. 6. FIG. 5 is a sectional view of a lamp holder 2a corresponding to FIG. 3 and FIG. 6 is a sectional view of a lamp holder 2b corresponding to FIG. 3.

The lamp holder 2a shown in FIG. 5 is configured such that one of the walls of the cutout groove 7a on the lower side is tilted with respect to the abutment surface T. Therefore, the width of the cutout groove is increased toward an opening of the cutout groove.

The lamp holder 2b shown in FIG. 6 is configured such that both of the walls of the cutout groove 7b on the upper and lower sides are tilted with respect to the abutment surface T. Therefore, the width of the cutout groove is increased toward the opening of the cutout groove.

Since the cutout grooves 7a and 7b are configured to have the width increased toward the opening, the edge of the reflector 4 is easily fitted in the cutout grooves 7a and 7b of the lamp holder 2. If the width of the cutout grooves 7a and 7b at the bottom is adjusted to be slightly smaller than the thickness of the reflector 4, the edge of the reflector 4 is firmly held in the cutout groove when an end face of the reflector 4 abuts the bottom surface of the cutout groove owing to the elastic force of the lamp holder 2.

### Embodiment 2

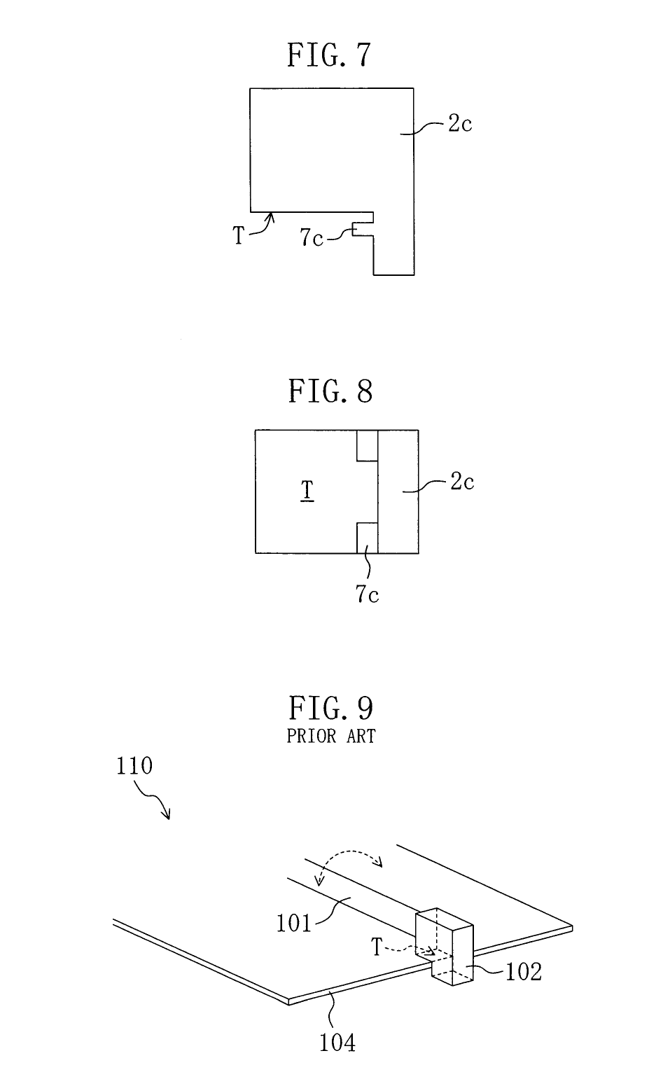

FIGS. 7 and 8 show a lamp holder 2c according to Embodiment 2 of the present invention. FIG. 7 is a sectional view of the lamp holder 2c corresponding to FIG. 3 and FIG. 8 is a bottom view of the lamp holder 2c. In this embodiment, the same components as those shown in FIGS. 1 to 6 are indicated by the same reference numerals to omit detailed explanation thereof.

As a feature of the present invention, the lamp holder 2c has a protrusion 7c protruding outward from the surface of the lamp holder 2c perpendicular to the abutment surface T. The protrusion 7c functions as a sandwiching part for sandwiching the edge of the reflector 4 between the abutment surface T and the upper surface of the protrusion 7c. Except for this feature, Embodiment 2 is the same as Embodiment 1.

With use of the thus-configured lamp holder 2c, the edge of the reflector 4 is sandwiched between the abutment surface T and the upper surface of the protrusion 7c of the lamp holder 2c. As a result, the lamp holder 2c is reliably secured to the edge of the reflector.

Other effects and configurations of the backlight unit and the liquid crystal display device are the same as those explained in Embodiment 1.

### Other Embodiments

In Embodiments 1 and 2, the direct backlight unit 10 is taken as an example. However, the present invention may also be applied to an edge-light type backlight unit.

### INDUSTRIAL APPLICABILITY

As described above, the present invention is useful for a backlight unit and a liquid crystal display device including the backlight unit.

1-7. (canceled)

8. A lamp holder attached to an end of a narrow lamp to secure the lamp to an edge of a reflector for reflecting light from the lamp, the lamp holder comprising:
an abutment surface abutting a surface of the edge of the reflector; and
a sandwiching portion arranged to sandwich the edge of the reflector between the abutment surface and the sandwiching portion.

9. The lamp holder of claim 8, wherein the sandwiching portion includes a cutout groove extending continuously along the abutment surface.

10. The lamp holder of claim 9, wherein a width of the cutout groove increases toward an opening of the cutout groove.

11. The lamp holder of claim 8, wherein the sandwiching portion is configured of an outward protrusion.

12. A backlight unit comprising:
a narrow lamp;
a reflector arranged to reflect light from the lamp; and
a lamp holder attached to an end of the lamp to secure the lamp to an edge of the reflector; wherein
the lamp holder includes an abutment surface abutting a surface of the edge of the reflector and a sandwiching portion arranged to sandwich the edge of the reflector between the abutment surface and the sandwiching portion.

13. The backlight unit of claim 12, wherein a plurality of the lamps are arranged substantially parallel to each other along the reflector.

14. A liquid crystal display device comprising:
a liquid crystal display panel; and
a backlight unit arranged to face a display surface of the liquid crystal display panel; wherein
the backlight unit includes a narrow lamp, a reflector arranged to reflect light from the lamp and a lamp holder attached to an end of the lamp to secure the lamp to an edge of the reflector and the lamp holder includes an abutment surface abutting a surface of the edge of the reflector and a sandwiching portion arranged to sandwich the edge of the reflector between the abutment surface and the sandwiching portion.
